(19) United States
(12) Patent Application Publication
(10) Pub. No.: US 2013/0108531 A1
(43) Pub. Date: May 2, 2013

(54) Process For Natural Gas Purification

(71) Applicant: Michael J. Mitariten, Pittstown, NJ (US)

(72) Inventor: Michael J. Mitariten, Pittstown, NJ (US)

(73) Assignee: Guild Associates, Inc., Dublin, OH (US)

(21) Appl. No.: 13/283,998

(22) Filed: Oct. 28, 2011

(51) Int. Cl. B01D 53/14; B01D 53/46; B01D 53/02; F25B 23/00; B01D 53/047; B01D 53/22

(52) U.S. Cl. 423/219; 95/236; 95/96; 95/139; 95/130; 95/54; 95/138; 62/467

(57) ABSTRACT

The present invention is directed toward a method for purifying a natural gas stream comprising: 1) removing the bulk of CO₂ by at least one non-membrane gas separation means; and 2) removing oxygen and other impurities by at least one additional gas separation means, wherein the final natural gas product has low level of CO₂ and oxygen.

### FIELD OF THE INVENTION

The present invention relates to processes that remove CO₂ and other impurities from a contaminated natural gas stream.

### BACKGROUND OF THE INVENTION

Natural gas is a general term that applies to the mixtures of inert and light hydrocarbon components, which are derived from natural gas wells, mines, gas associated with the production of oil, or from digesters and landfills. Typically, the quality of the natural gas, as produced, will vary according to the content and amount of inert gases (i.e., nitrogen, carbon dioxide, oxygen and helium) and other impurities. These inert gases not only reduce the heating value of the natural gas, but in some cases, such as carbon dioxide in combination with the water within the natural gas, also render the natural gas corrosive.

Carbon dioxide and oxygen are present in landfill gas and coalmine methane in almost all cases and are occasionally present in other methane and natural gas streams. Pipeline acceptance of gases from such sources requires that the gas meet pipeline quality, which includes specific limits on impurities such as water vapor, hydrogen sulfide, carbon dioxide, nitrogen and oxygen.

The removal of these impurities with the exception of oxygen is well proven and well established. Further, the pipeline specifications on permitted levels of oxygen range widely and we have seen cases requiring a low of 10 ppm to a high of 1%. This large range of permitted oxygen impacts the technologies and processing for its removal.

In the case of purifying natural gas from landfills, landfill gas compositions include a feed stream that is typically about 50% methane, 40% CO₂, and with the balance composed of primarily nitrogen plus oxygen with a typical oxygen level of up to 2%. Current means to upgrade landfill gas by removing the CO₂ impurity encompasses a variety of technologies including liquid solvent-based CO₂ wash systems, membrane units where the CO₂ is removed by permeation from high pressure to low pressure and PSA systems where CO₂ is adsorbed and removed from the landfill gas. Of these technologies, the membrane unit offers the added advantage that oxygen will permeate to a substantial extent when the CO₂ is removed, however it is not always applied due to patent limitations and other issues.

Wash systems are commonly used for the removal of CO₂ from the natural gas. Solvents such as a dimethylether of polyethylene glycol and alkanolamines, alkali metal salts or even water is used to absorb and remove the carbon dioxide. Stripping of CO₂ with pressure reduction, air stripping and/or heating of the solvent subsequently regenerates the CO₂-rich solvent.

Carbon dioxide removal by membranes is well documented in U.S. Pat. No. 5,411,721 to Doshi et al., in which the unprocessed natural gas feed is passed through a gas permeable membrane that operates at a pressure effective, in order to separate the unprocessed natural gas feed into a methane-depleted permeate stream and a carbon dioxide-depleted non-permeate stream. The permeate stream is then passed into a PSA system to produce a methane-rich stream that is essentially free of carbon dioxide, and a tail gas stream that is comprised of carbon dioxide. The carbon dioxide-depleted non-permeate stream is then combined with the methane-rich stream from the PSA to provide a high-quality natural gas stream.

However, besides the above-mentioned obstacles for using membranes, the membranes will pass a portion of the less permeable gases along with the preferentially separated gas, thereby limiting the recovery of the non-permeable gases and producing a low-quality permeate stream. As a result of this limitation, multiple membranes are used in sequential stages, so that the permeate stream from later stages can be recycled to the first or the previous stage to improve the separation and reduce losses. The cost of these additional membrane stages and the subsequent recompression and recycling are significant, as membranes do not provide any economy of scale with increases in gas capacity for the same separation. Furthermore, the cost of membrane technology is directly proportional to the area of the membrane employed. U.S. Pat. No. 4,130,403 to Cooley et al., is an example of the use of multiple stages of membrane separation to obtain a carbon dioxide-rich permeate stream. PSA is a technology that separates some gas species from a mixture of gases under pressure according to the species' molecular characteristics and affinity for an adsorbent material. However, PSA with conventional adsorbents has a relatively low selectivity between methane and carbon dioxide. Consequently, a large amount of methane is co-adsorbed along with the carbon dioxide, which leads to high losses of methane into the tail gas and larger adsorbent inventories. This is a particular concern, as methane is often the desirable end product gas.

Furthermore, for the purification of a landfill feed, the removal of oxygen and nitrogen is also highly desirable. Yet prior art methods, aside from the costly membranes, are not able to remove an appreciable amount of oxygen

Therefore, there still remains a need for cost-effective and efficient methods to remove impurities from contaminated natural gas stream to produce high-quality product gas.

### SUMMARY OF THE INVENTION

The present invention is directed toward a novel process for removing impurities from a natural gas stream to yield a final desirable product stream. The process comprises first removing the bulk of the carbon dioxide from the natural gas stream with at least one non-membrane gas separation means, then subsequently removing other impurities, such as O₂, with at least one gas separation means.

### DESCRIPTION OF THE DRAWINGS

FIG. 1A depicts bulk removal of CO₂ by non-membrane gas separation means, and O₂ removal by membrane permeation from a contaminated natural gas stream.

FIG. 1B depicts the bulk removal of CO₂ by non-membrane gas separation means, and O₂ removal by a PSA system from a contaminated natural gas stream.

FIG. 2A depicts the bulk removal of CO₂ by non-membrane gas separation means, followed by the partial removal of the residual CO₂ and O₂ in a Stage Two membrane and a further removal of CO₂ and O₂ in a Stage Three membrane, wherein the permeate from the Stage Three membrane is recycled back to the main feed of a contaminated natural gas stream.

FIG. 2B depicts an alternative process for the bulk removal of CO₂ and removal O₂ by two-stage membrane permeation from a contaminated natural gas stream, wherein the permeate from the Stage Three membrane is compressed then mixed with an intermediate feed.

FIG. 3A depicts the bulk removal of CO₂ and a combination of a membrane unit and a PSA system that removes O₂ and optionally N₂ from a contaminated natural gas stream.

FIG. 3B depicts an alternative process that removes CO₂ in bulk, and a combination of a membrane unit and a PSA system that removes O₂ and optionally N₂ from a contaminated natural gas stream.

FIG. 4A depicts still another process for the bulk removal of CO₂, and a combination of a PSA system and a membrane unit to remove O₂ and optionally N₂ from a contaminated natural gas stream.

FIG. 4B depicts yet another alternative process for bulk removal of CO₂, and a combination of a PSA system and a membrane unit that removes O₂ and optionally N₂ from a contaminated natural gas stream.

FIG. 5A depicts a process that removes CO₂ in bulk, followed by a deoxo system and subsequent PSA system to remove O₂, N₂ and other impurities from a contaminated natural gas stream.

FIG. 5B depicts an alternative process that removes CO₂ in bulk, followed by a PSA system and subsequent deoxo system to remove O₂, N₂ and other impurities from a contaminated natural gas stream.

FIG. 6A depicts a process that removes CO₂ in bulk, followed by a partial removal of the residual CO₂ and O₂ in a Stage One membrane and recovery of methane in a Stage Two membrane, and recycle back to the intermediate feed.

FIG. 6B depicts a process that removes CO₂ in bulk, followed by a partial removal of the residual CO₂ and O₂ in a Stage Two membrane, formation of a purified natural gas product in a PSA system and further recovery of methane in a Stage Three membrane, and recycle back to the intermediate feed.

### DETAILED DESCRIPTION OF THE INVENTION

The present invention is directed toward a novel process that removes CO₂, O₂, and other impurities from a contaminated natural gas stream, in order to yield a final desirable product stream. The process comprises first substantially removing the bulk of the carbon dioxide with at least one non-membrane gas separation means, and then removing O₂ and other impurities with at least one gas separation means.

Contaminated natural gas streams are typically associated with natural gas wells, mines, landfills and gas associated with the production of oil. It must be noted that in the present invention, “impurities” are gases or liquids that are unwanted in natural gas streams to be forwarded as pipeline gas. The impurities of the present invention are typically comprised of nitrogen, carbon dioxide, oxygen, sulfur and/or other gases that are undesirable in pipeline natural gas due to low heat value, cause pipeline corrosion, or result in noxious products during combustion.

### CO₂ Removal

In the process of this invention, carbon dioxide is substantially removed from the contaminated natural gas stream prior to the removal of other impurities. This removal is also known as Bulk Carbon Dioxide Removal (“BCDR”). At least 20%, preferably at least 25%, and more preferably at least 30% of the carbon dioxide contained in the natural gas stream is removed during BCDR. BCDR is accomplished by at least one gas separation means that is selected from solvent-based wash systems, CO₂ refrigeration systems, CO₂ wash systems (i.e. Acrion CO₂ wash system), molecular sieves, carbon ion pumps and PSA systems. No membrane units are used for BCDR in this invention.

The BCDR may also include the capability to remove other impurities including but not limited to water vapor, H₂S, other sulfurs, VOCs. halides, siloxanes, NH₃ and other components as might be found in contaminated gas stream.

As mentioned hereinabove, wash systems are commonly used to remove CO₂ from natural gas. Wash systems often contain solvents such as a physical solvent of dimethylether of polyethylene glycol or chemical solvents such as alkanolamines, refrigerated methanol, water or alkali metal salts to wash out and absorb carbon dioxide. In CO2 removal from landfill gases and digester gases water is a common solvent. The alkanolamines that are used can be in the primary, secondary, or tertiary forms. Monoethanolamine is an example of a well-known primary alkanolamine. Conventionally used secondary alkanolamines include diethanolamine and diisopropanolamine. Conventionally used tertiary alkanolamines are triethanolamine and methyldiethanolamine, which are known to absorb carbon dioxide from industrial gas mixtures. Suitable alkali metal salts are the alkali metal salts of α-amino acids, such as N,N-dimethylglycine(dimethylaminoacetic acid), N,N-diethylglycine(diethylaminoacetic acid), N,N-dimethylalanine(α-dimethylamino-propionic acid), N,N-dimethylleucine(2-dimethylamino4-methylpentan-1-oic acid), N,N-dimethylisoleucine(α-dimethylamino-β-methylvaleric acid), N,N-dimethylvaline(2-dimethylamino-3-methylbutanoic acid), N-methylproline (N-methylpyrrolidine-2-carboxylic acid), N,N-dimethylserine(2-dimethylamino-3-hydroxypropan-1-oic acid), β-amino acids, such as 3-dimethylaminopropionic acid, N-methyliminodipropionic acid, N-methylpiperidine-3-carboxylic acid, or aminocarboxylic acids such as N-methylpiperidine-4-carboxylic acid, 4-dimethylaminobutyric acid. Particularly preferred amino acid salts (A) are N,N-dimethylaminoacetic acid potassium salt, N,N-diethylaminoacetic acid potassium salt, and N-ethyl-N-methylaminoacetic acid potassium salt.

In one embodiment, after the alkanolamine solution absorbs the carbon dioxide, the solution is regenerated to remove the absorbed gas. The regenerated alkanolamine solution can then be recycled for further absorption. Absorption and regeneration are usually carried out in different columns that contain packing or bubble plates for an efficient operation. Regeneration is generally achieved in two stages. First, the absorbent solution's pressure is reduced so that the absorbed carbon dioxide is vaporized from the solution in one or more flash regenerating columns. Next, the flashed absorbent is stripped by steam in a stripping regenerating column to remove any residual absorbed carbon dioxide.

Size selective molecular sieves, equilibrium based molecular sieves and other adsorbents also effectively adsorb and remove carbon dioxide in bulk. Size selective molecular sieves comprise porous materials that exclude larger molecules, but trap small molecules such as carbon dioxide. Useful molecular sieves are selected from zeolite molecular sieves, ETS sieves, activated clays and the various forms of silicoaluminophosphates and aluminophosphates that are disclosed in U.S. Pat. No. 4,440,871 to Lok et al.; U.S. Pat. No. 4,310,440 to Wilson et al.; and U.S. Pat. No. 4,567,027 to Detournay et al., which are incorporated herein by reference. Typical well-known zeolites include chabazite (also known as Zeolite D), clinoptilolite, erionite, faujasite (also known as Zeolite X), Zeolite Y, ferrierite, mordenite, Zeolite A and Zeolite P. Other zeolites that are also useful are those that have a high silica content, i.e., those that have silica to alumina ratios greater than 10 and typically greater than 100. One such high silica zeolite is silicalite, and the term that is used herein includes both the silicapolymorph as disclosed in U.S. Pat. No. 4,061,724 to Grose et al. and the F-silicalite as disclosed in U.S. Pat. No. 4,073,865 to Flanigen et al., which are incorporated herein by reference.

ETS molecular sieves that are suitable for CO₂ adsorption possess octahedrally coordinated active sites in the crystalline structure. These molecular sieves also contain electrostatically charged units, which are radically different from charged units in conventional tetrahedrally coordinated molecular sieves. Members of the ETS family of sieves include, by way of example, ETS-4 (U.S. Pat. No. 4,938,939), ETS-10 (U.S. Pat. No. 4,853,202) and ETAS-10 (U.S. Pat. No. 5,244,650), all of which are titanium silicates or titanium aluminum silicates. The disclosures of each of the listed patents are incorporated herein by reference.

Other molecular sieves such as carbon molecular sieve (“CMS”) and carbon fiber composite molecular sieves (“CFCMS”) also effectively trap CO₂ in bulk. CMS is a carbonaceous adsorbent with uniform pores that are smaller than 10 Å in pore diameter. CMS are commercially available from providers such as Japan EnviroChemicals among others. For the CFCMS, Petroleum pitch-derived carbon fiber and a phenolic resin derived carbon binder are mixed to produce the sieves, so that the sieves comprise a rigid and strong monolith with an open structure that allows for a free-flow of fluids. Activation (selective gasification) of CFCMS creates a microporosity that has high micropore volumes (>0.5 cm³/g) and BET surface areas (>1000 m²/g).

The above-mentioned molecular sieves may also be metalized with at least one metal selected from the group consisting of groups IB, IIB, IIIA, IIIB, VB, VIB, VIIB and VIII of the periodic table. Specifically, the metal can be selected from the group that is consisted of Cr, Co, Cu, Fe, Hf, La, Ce, In, V, Mn, Ni, Zn, Ga and the precious metals Ag, Au, Pt, Pd and Rh.

Carbon dioxide can also be adsorbed selectively over methane by equilibrium-based adsorbents such as large pore molecular sieves (large pore being molecular sieves with pore sizes large enough to admit methane as well as the smaller carbon dioxide molecule), activated carbons, aluminas, silica gels, and metal oxide adsorbents.

Another method for removing carbon dioxide is the usage of carbon ion pumps. Briefly, the contaminated natural gas stream is flowed through a water-wash system, so that the CO₂ from the contaminated natural gas stream is dissolved in water to produce carbonate ions, which results in an ionic solution. The ionic solution is then flown through a plurality of flow channels, and one or more pairs of conductive plates are adapted about the plurality of flow channels. The plates apply a periodic electric field to produce an overlying vapor pressure within the ionic solution. The vapor pressure enables the CO₂ to be extracted and sequestered as a pure gas. The methods and apparatus for removing carbon dioxide with carbon ion pumps are taught in U.S. Pat. No. 7,828,883 to Aines et al., which is incorporate herein by reference.

An important method for removing carbon dioxide is the usage of PSA systems with equilibrium adsorption based or size selective adsorbents as discussed above. Pressure swing adsorption (PSA) is of itself a well known means of separating and purifying a less readily adsorbable gas component contained in a feed gas mixture of said component with a more readily adsorbable second component, considered as an impurity or otherwise. Adsorption commonly occurs in multiple beds at an upper adsorption pressure, with the more selectively adsorbable second component thereafter being desorbed by pressure reduction to a lower desorption pressure. The beds may also be purged, typically at such lower pressure for further desorption and removal therefrom of said second component, i.e., the removal of impurities with respect to a high purity product gas, before repressurization of the beds to the upper adsorption pressure for the selective adsorption of said second component from additional quantities of the feed gas mixture as the processing sequence is carried out, on a cyclic basis, in each bed in the PSA system. Such PSA processing is disclosed in U.S. Pat. No. 3,430,418 to Wagner, and in U.S. Pat. No. 3,986,849 to Fuderer et al., wherein cycles based on the use of multi-bed systems are described in detail. Such cycles are commonly based on the release of void space gas from the product end of each bed, in so called co-current depressurization step(s), upon completion of the adsorption step, with the released gas typically being employed for pressure equalization and for purge gas purposes. The bed is thereafter counter-currently depressurized and/or purged to desorb the more selectively adsorbed component of the gas mixture from the adsorbent and to remove such gas from the feed end of the bed prior to the repressurization thereof to the adsorption pressure. An evacuation step may be added following the countercurrent depressurization step and before the repressurization step to further remove the adsorbed component from the adsorbent.

It is within the scope of the present invention for the PSA system to produce a secondary product gas at a much lower pressure than the pressure of the high purity product gas. The secondary product from the PSA system is produced by the addition of a co-current depressurization step to the PSA cycle. In a typical PSA cycle, at least one adsorbent bed of a multiple adsorbent bed system undergoes an adsorption step wherein the feed gas is introduced at a feed end of the adsorbent bed and the high purity product or in this invention methane-rich stream is withdrawn from the effluent end of the adsorbent bed. The adsorbent bed is then co-currently depressurized in an equalization step and the equalization gas is used to repressure another adsorbent bed. The co-current depressurization step is continued to provide a purge gas for regeneration of another adsorbent bed. At the end of the provide purge step, typically the adsorbent bed is counter-currently depressurized to the lowest desorption pressure. Typically, the lowest desorption pressure ranges from about 350 kPa (50 psia) to about atmospheric pressure. Preferably, the lowest desorption pressure is below atmospheric pressure. In the instant invention, for the production of the secondary product stream, the adsorption bed may be co-currently depressurized before or following the provide purge step to provide the secondary product gas. The adsorbent bed is then counter-currently depressurized (commonly referred to as the “blowdown” step) and the waste gas, or tail gas stream is withdrawn. The tail gas stream may be vented, flashed or used as a low-grade fuel. The secondary product gas stream would contain substantially more carbon dioxide impurity than the high purity product gas. In the operation of a PSA system of the present invention to reject carbon dioxide, preferably the high purity product gas or methane-rich stream essentially free of carbon dioxide will contain less than about 30 mol % carbon dioxide, more preferably less than about 20 mol % and most preferably about 2 to about 10 mol %. When a secondary product gas stream is used, it will contain a percentage of carbon dioxide that is higher than the product stream. The secondary product gas can be used as a fuel, to drive the compressor, or to generate electrical power through the use of gas turbines. The secondary product stream can also be recycled back to the feed to improve the methane recovery of the overall PSA system.

The PSA system can be operated with at least one, and typically at least two adsorbent beds, as may be desirable in given applications, with from 3 to about 12 or more adsorbent beds commonly being employed in conventional practice. As in conventional practice, any suitable adsorbent material may be used in the PSA system of the invention.

The above-mentioned means can be used alone or in combination, and there is no preferred sequence of the combined means. Accordingly, the above-mentioned means to remove CO₂ may also adsorb and remove other impurities such as N₂ water vapor, H₂S, other sulfurs, VOCs. halides, siloxanes, NH₃ and other components as might be found in contaminated gas stream with or without further adjustments.

### O₂ Removal

After the bulk of the CO₂ is removed from the natural gas stream, at least one gas separation means is applied to remove oxygen and, optionally, other impurities from the subsequent, high-pressured intermediate product feed. The oxygen and/or nitrogen removal is accomplished by at least one gas separation means that is selected from membrane permeation, catalyst-assisted combustion, metal adsorption and PSA systems. In one embodiment, the intermediate product feed is preferably processed by a membrane permeation system. In another embodiment, the intermediate product feed is preferably processed by a PSA system. In yet another embodiment, the intermediate product feed is preferably processed by a membrane permeation system that is followed by a PSA system, or a PSA system that is followed by a membrane permeation system. The membranes and PSA system may or may not be dehydrated prior to their usage to purify the intermediate feed.

In the membrane permeation system, the high-pressured intermediate product feed having a reduced CO₂ concentration relative to the CO₂ content of the natural gas feed, such as from a landfill or the like, enters a membrane unit and leaves as a retained product gas at low pressure, while the membrane unit permeates the oxygen and other impurities such as the residual CO₂. The resulting natural gas product retained by the membrane has an oxygen level up to about 5,000 ppm.

Various suitable designs of membrane permeation systems can be used depending upon the desired gas separation. Thus, the membrane unit may be employed in plate and frame form, or may comprise spiral wound film membranes, tubular membranes, hollow fiber membranes, or the like. The use of hollow fiber membranes is generally preferred due to the high surface area per unit of membrane that can be obtained thereby. It will be appreciated that, when membranes are used in a tubular or hollow fiber form, a plurality of such membranes can be conventionally arranged in a parallel bundle form. In such embodiments, the feed gas stream can be brought into contact with either the outer or shell side, or the inner or tube side of the membrane fibers. Those skilled in the art will appreciate that the flow of the feed gas and of the permeated gas within the separation zone can be either co-current or countercurrent. Bundles of hollow fiber and tubular membranes enable the feed gas to pass either radially or axially, with respect to the direction in which the hollow fibers or tubular membranes are positioned within the separation zone.

Membranes or membrane units are typically made from metallic or inorganic materials, as well as various organic polymeric materials or organic polymeric materials that are mixed with inorganic materials that act as fillers, reinforcements and the like. Organic polymers that used to produce membranes include such materials as polysulfones; polystyrenes, including such styrene-containing polymers as acrylonitrile, styrene copolymers, styrene-butadiene and styrene-vinylbenzyl halide copolymers; cellulosic polymers, such as cellulose acetate, cellulose acetate-butyrate, methyl or ethyl cellulose; polyamides and polyimides; polycarbonates; polyurethanes; polyesters, including polyacrylates, polyethylene; polypropylene; polyvinyl pyridines, and the like. Such polymers may be either substituted or unsubstituted, with typical substituents of such substituted polymers including halogens, such as chlorine, fluorine and bromine; hydroxyl groups; lower alkyl groups; monocyclic aryl; lower acyl groups, etc.

The use of permeable membranes in conjunction with coating materials is also known, and such combinations enable a good selectivity of gas separation. Typical coatings include substituted or unsubstituted polymers that are either solid or liquid under gas separation conditions. Examples of such coating materials include synthetic and natural rubbers, organic prepolymers, polyurethanes, polyamines, polyesters and the like. The coatings may be polymerized either before or after their incorporation into the permeable membranes.

For gas transmission via pipeline, the acceptable oxygen level ranges widely and is almost always lower than 5000 ppm, often lower than 4000 ppm and commonly 2000 ppm or less and preferably less than 1000 ppm. To achieve this requirement with membrane permeation, the use of additional membrane units would cause more methane to permeate, which results in a substantially lower methane recovery.

To overcome the methane recovery issue, a catalyst-assisted combustion of oxygen can be implemented to remove the residual oxygen from the retained product gas. In this method, oxygen reacts with the product gas over a catalyst bed to form water and CO₂, which, if desired, can then be subsequently separated from the product gas. The amount of water and CO₂ formed is directly related to the concentration of oxygen in the retained product gas. Such catalytic systems are well known in industry, and have been applied at facilities where oxygen is required to be removed to low ppm levels, such as 10 ppm. The catalyst that is used in the bed is selected from a Group VIB metal and/or a Group VIII metal, optionally on a support. Suitable metals include cobalt, nickel, molybdenum, tungsten, and combinations thereof. Suitable supports include silica, silica-alumina, alumina, and titania. A preferred embodiment includes a catalyst that is comprised of a Group VIB metal and a Group VIII metal (e.g., in oxide form, or preferably after the oxide form has been sulfidized under appropriate sulfidization conditions), optionally on a support. The catalyst may additionally or alternately contain additional components, such as other transition metals (e.g., Group V metals such as niobium), rare earth metals, organic ligands (e.g., as added or as precursors left over from oxidation and/or sulfidization steps), phosphorus compounds, boron compounds, fluorine-containing compounds, silicon-containing compounds, promoters, binders, fillers, or like agents, or combinations thereof. Copper oxide that optionally combined with other metals on a carrier is also useful. The metals that are combinable with copper oxide may include copper, and other metals and/or oxides of other metals such as zinc, palladium, platinum, gold, and silver, as described in U.S. Patent Application Number 2011/0027156 Eisinger et al., which is incorporated herein by reference.

Another useful method for removing oxygen is its adsorption by reduced metals. The method is comprised of passing the intermediate product feed over at least one reduced metal that is selected from the group consisting of Ni, Co, Cu, Fe, Mn and Ag, so that the reduced metal reacts with and removes the oxygen from the intermediate feed. The metal reduction is achieved by withdrawing a portion of the intermediate product feed, mixing it with hydrogen, then passing the mixture over the metal. Methods and apparatus that remove oxygen by reduced metals are taught in U.S. Patent Application Number 2010/0028229 to Carnell et al., which is incorporated herein by reference.

A PSA system with at least one adsorbent bed also effectively removes oxygen. After BCDR, the PSA system can be used alone, prior to, or after other gas separation systems.

The PSA system is typically comprised of at least one bed that adsorbs and releases impurities at selective pressure levels, and at least one means to apply such pressure levels. At least one bed is comprised of the same or different types of adsorbents that adsorb impurities at a high-pressure level, and thereafter the bed is counter-currently depressurized and/or purged to release the previously adsorbed impurities. The impurities are subsequently removed from the bed, prior to bed re-pressurization to a pressure that reinitializes the bed to adsorb more impurities on a cyclic basis.

The PSA system often operates with at least one, and typically at least two adsorbent beds, however three to about twelve or more adsorbent beds are also possible. The adsorbents that are used to remove oxygen from natural gas are carbon molecular sieve (CMS) and/or contracted titanium silicates (commonly referred to as Molecular Gate CTS-1). These adsorbents may be used alone or in combination. A more detailed description of the PSA process is provided above with respect to removal of CO₂ from the natural gas feed. The same principals of PSA processing apply to removal of O₂ and other impurities during carbon molecular sieve or Molecular Gate CTS-1 adsorbent beds in PSA. It is recognized that future advances in oxygen adsorbing media may be developed and would be applied in the process steps identified in this application.

### Other Impurities

Besides carbon dioxide and oxygen, it is also desirable to remove other impurities such as nitrogen, volatile organic compounds (“VOCs”), halides, siloxanes, residual oxygen and carbon dioxide, hydrogen, siloxanes and/or sulfur gas from natural gas. To remove nitrogen, notable methods use adsorbents, such as molecular sieves and transition metals. To remove other impurities, “deoxo” catalysts can be used. To remove siloxanes and VOCs activated carbon beds, silica gel or alumina beds, refrigeration etc and other methods well known in industry can be used.

One type of molecular sieve that is known to specifically adsorb nitrogen and residual CO₂ are primarily made of crystalline titanium silicate that is based on ETS-4, a novel molecular sieve formed of octrahedrally coordinated titania chains that are linked by tetrahedral silicon oxide units. These ETS-4 sieves are further modified to include heavier alkaline earth cations such as barium. It has also been found that in appropriate cation forms, the pores of ETS-4 can systematically shrink from slightly larger than 4 Å to less than 3 Å in diameter during calcinations, while maintaining substantial sample crystallinity. These pores may be frozen at any intermediate size by ceasing the sieve's thermal treatment at an appropriate point and returning the sieve to ambient temperatures. These sieves that have controlled pore sizes are referred to as “contracted titano silicate-1” (“CTS-1”) and are described in U.S. Pat. No. 6,068,682 to Kuznicki, et al., which is incorporated herein by reference in its entirety.

These CTS-1 molecular sieves, as known commercially as Molecular Gate® CTS-1, are particularly effective in separating nitrogen and acid gases selectively from methane. The pores of the CTS-1 molecular sieves can be shrunk to a size that effectively adsorbs the smaller nitrogen and carbon dioxide, yet excludes the larger methane molecule. Molecular Gate® CTS-1 can also be use alone, before, after or simultaneously with other waste stream separation systems. Molecular Gate® CTS-1 and other various modified sieves in combination with PSA systems to remove nitrogen are known and taught by U.S. Pat. No. 5,989,316, to Kuznicki, et al. and U.S. Pat. No. 6,315,817 to Butwell, et al., which are incorporated herein by reference.

Transition metals also adsorb nitrogen from the contaminated natural gas streams. This can be achieved by passing the stream through a solvent that is comprised of nitrogen ligand, mono/multidentate ligand, and a transition metal complex that includes at least one metal selected from Cr, W, Mn, Fe, Co, and Ni. Details of the method and apparatus that remove nitrogen by liquid transition metal complex can be found in U.S. Pat. No. 6,077,457 to Friesen et al., which is incorporated herein by reference.

To remove other impurities, “deoxo” catalysts that are comprised of metal or metal oxides may be implemented before or immediately after BCDR, and before or immediate after O₂ removal. Useful “deoxo” catalysts are selected from copper oxide on a high surface area alumina sphere carrier (e.g. Cu-0226 S, Puristar R3-11G), palladium on an alumina carrier (e.g. Puristar R0-20), palladium on a special Al₂O₃ carrier (e.g. Puristar R0-25), or a mixed metal catalyst that is composed of CuO and ZnO (e.g. Puristar R3-15).

### DETAILED DESCRIPTION OF THE DRAWINGS

The following figures demonstrate various implementations of the above-mentioned gas separation means for removing impurities from a contaminated natural gas stream to produce a product gas, which can be directed to pipeline systems. However, the invention is not restricted to the combinations of means that are shown in the figures, and other combinations of the mentioned-above means are possible.

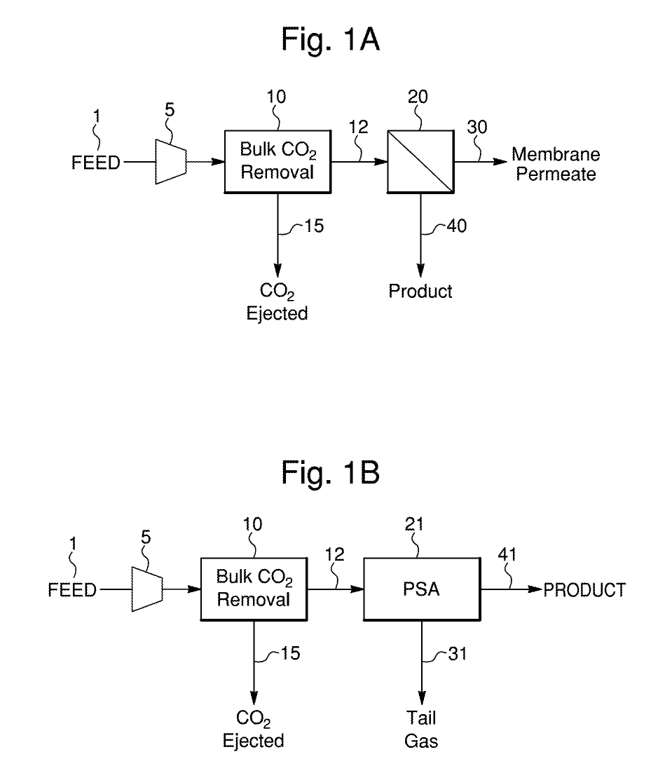

FIG. 1A illustrates a contaminated natural gas stream purification procedure that is comprised of two stages. Initially, a contaminated natural gas stream 1 is compressed by compressor 5, and then transmitted to means 10 for BCDR, which is comprised of at least one non-membrane separation means, such as solvent-based wash systems, molecular sieves, carbon ion pumps and PSA systems. The BCDR means 10 ejects CO₂ via line 15. An intermediate feed product from the BCDR means 10, having a substantially reduced CO₂ concentration relative to feed 1 is transmitted via line 12 to a second stage, wherein a membrane means 20 further processes the intermediate feed product to produce a retained and purified natural gas product via line 40, having a low level of O₂ relative to the intermediate feed product, and a membrane permeate via line 30, having an O₂ level that is higher than the intermediate feed product. The membrane permeate typically comprises natural gas, O₂, water, sulfur, residual CO₂ and other impurities.

FIG. 1B illustrates a contaminated natural gas stream purification procedure that is comprised of two stages. Initially, a contaminated natural gas stream 1 is compressed by compressor 5 then transmitted to means 10 for BCDR, which is comprised of at least one non-membrane gas separation means, such as solvent-based wash systems, molecular sieves, carbon ion pumps and PSA systems. The BCDR means 10 ejects CO₂ via line 15. An intermediate feed product from the BCDR means 10, having a reduced CO₂ content relative to feed 1 is transmitted via line 12 to the second stage, wherein a PSA means 21, as previously described and containing one or multiple adsorbent beds further processes the intermediate feed product to produce a non-adsorbed and purified natural gas product via line 41, which has a lower level of O₂ relative to the intermediate feed product, and a low pressure tail gas via line 31, which has a higher level of O₂ relative to the intermediate feed product. The PSA means 21 may include one or more adsorbents to adsorb O₂, and one or more of CO₂, N₂, and other impurities. The tail gas comprises natural gas, O₂, and other impurities.

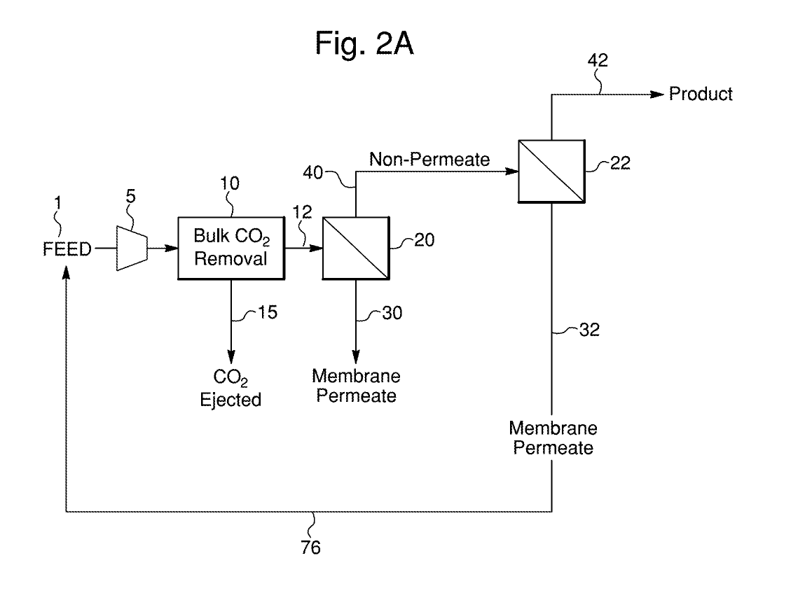

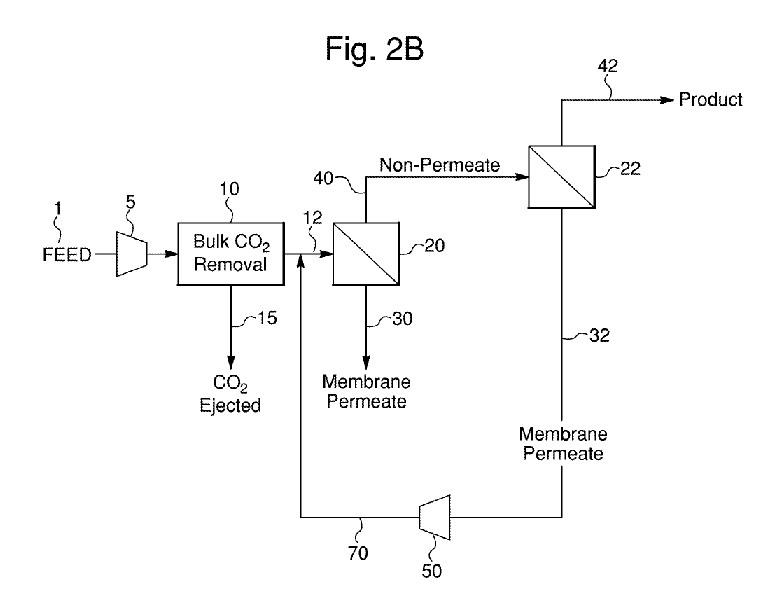

FIG. 2A illustrates a contaminated natural gas stream purification procedure that is comprised of three stages. Initially, a contaminated natural gas stream 1 is compressed by compressor 5 then transmitted to means 10 for BCDR, which is comprised of at least one non-membrane gas separation means, such as solvent-based wash systems, molecular sieves, carbon ion pumps and PSA systems. The BCDR means 10 then ejects CO₂ via line 15. An intermediate feed product from the BCDR means 10 is transmitted to a second stage via line 12, wherein a membrane means 20 further processes the intermediate feed product to produce a retained and purified natural gas product (non-permeate) via line 40, which has a lower level of O₂ relative to the intermediate feed product, and a membrane permeate via line 30, which has a higher level of O₂ relative to the intermediate feed product. The membrane permeate comprises natural gas, O₂, and other impurities. The non-permeate, which contains a major portion of natural gas, is further transmitted to the third stage, wherein a second membrane means 22 further processes the natural gas to a purified retained natural gas product via line 42, and a second membrane permeate via line 32, which contains some natural gas as well as O₂ and other impurities from the natural gas feed 1. The second membrane permeate via line 32 is mixed with the feed 1 to improve overall natural gas yield.

FIG. 2B illustrates a similar process flow as FIG. 2A, except that the second membrane permeate via line 32 is compressed by compressor 50 and mixed via line 70 with the intermediate feed product at line 12 prior to initial membrane separation to improve natural gas yield.

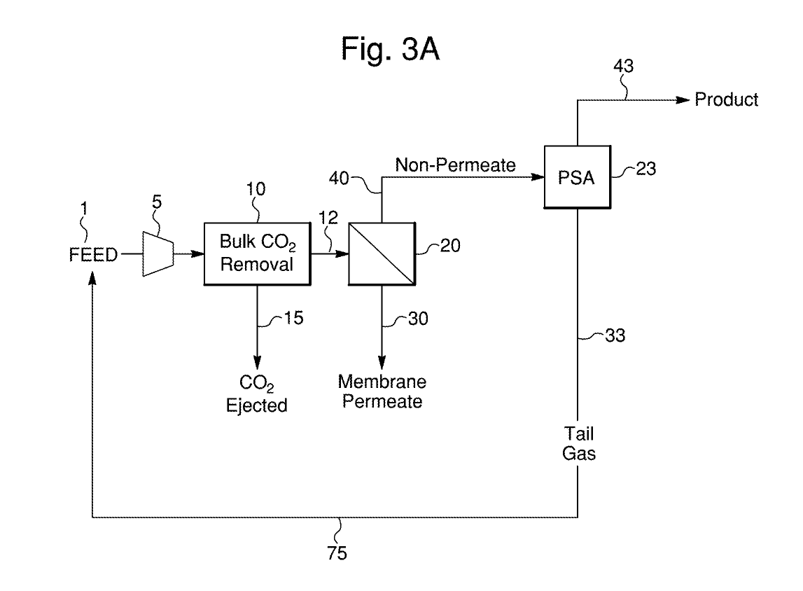

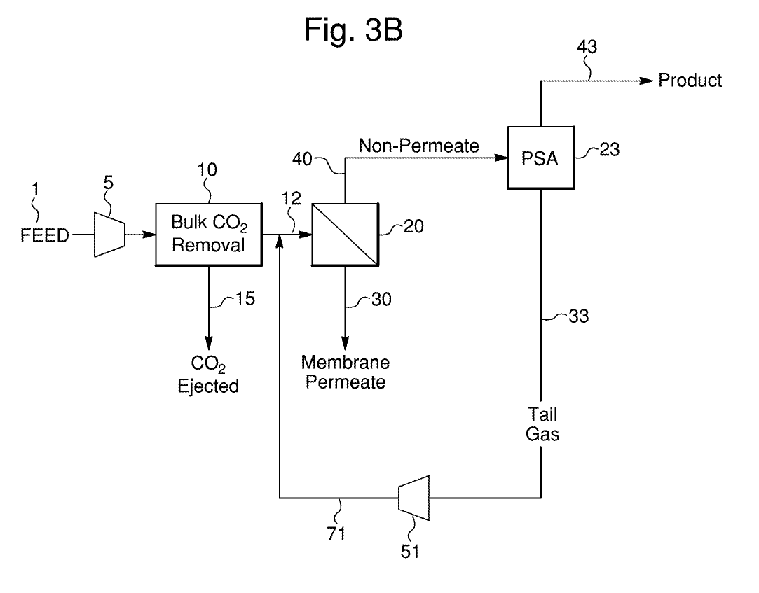

FIG. 3A illustrates a contaminated natural gas stream purification procedure that is comprised of three stages. Initially, a contaminated natural gas stream 1 is compressed by compressor 5 then transmitted to means 10 for BCDR, which is comprised of at least non-membrane gas separation means, such as solvent-based wash systems, molecular sieves, carbon ion pumps and PSA systems. The BCDR means 10 then ejects CO₂ via line 15. An intermediate feed product from the BCDR means 10 is transmitted to the second stage via line 12, wherein a membrane means 20 further processes the intermediate feed product to produce a retained and purified natural gas product (non-permeate) via line 40, which has a lower level of O₂ than the intermediate feed product, and a membrane permeate via line 30, which has a higher level of O₂ than the intermediate feed product. The membrane permeate 30 comprises natural gas, O₂ and other impurities. The non-permeate is further transmitted to the third stage, wherein a PSA means 23 processes the non-permeate to a non-adsorbed and purified natural gas product via line 43, which has a greatly reduced concentration of impurities than the non-permeate from line 40, and a low-pressure tail gas via line 33, which contains some natural gas and a higher concentration of impurities such as O₂, N₂, CO₂, etc., depending on the nature of the adsorbent used upon the non-permeate from line 40. For example, the PSA means 23 may include a Molecular Gate® CTS-1 to adsorb N₂. The tail gas 33 is then mixed with the feed 1 via line 75 to be further processed to recover additional natural gas. The recycle of the tail gas 33 is optional and the tail gas may be directed to leave the system as an impurity containing stream.

FIG. 3B illustrates a similar process as shown in FIG. 3A, except that the tail gas via line 33 is compressed by a compressor 51 and mixed via line 71 with the intermediate feed product at line 12 to further recover natural gas volume. The recycle of the tail gas 33 is optional and the tail gas may be directed to leave the system as an impurity containing stream.

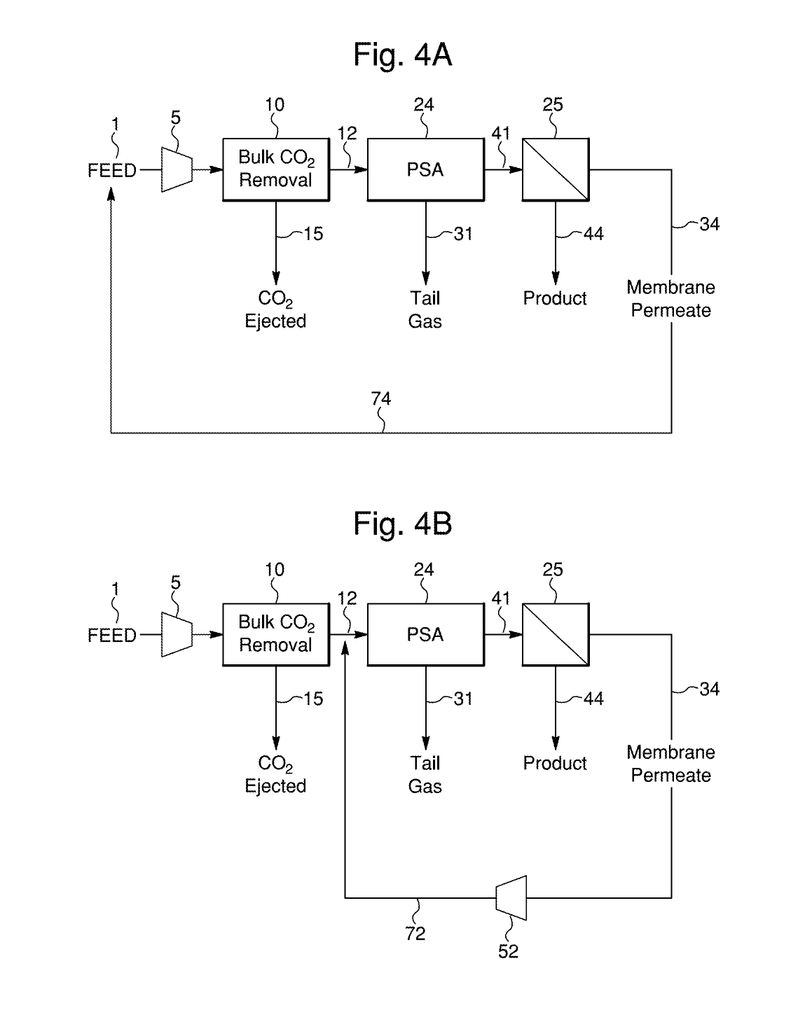

FIG. 4A illustrates a contaminated natural gas stream purification procedure that is comprised of three stages. Initially, a contaminated natural gas stream 1 is compressed by compressor 5 then transmitted to means 10 for BCDR, which is comprised of at least one non-membrane gas separator means, such as solvent-based wash systems, molecular sieves, carbon ion pumps and PSA systems. The BCDR means 10 then ejects CO₂ via line 15. An intermediate feed product is transmitted to a second stage PSA means 24 via line 12, which processes the intermediate feed product to a non-absorbed and purified natural gas second intermediate feed product via line 41, which has a lower level of O₂ than the first intermediate feed product. A tail gas via line 31 is produced from the adsorbed contaminants, which has a higher concentration of O₂ than the first intermediate stream product stream. The tail gas via line 31 comprises some natural gas and relatively high levels of contaminants such as O₂, N₂, CO₂, etc, depending on the adsorbent utilized. The second intermediate feed product via line 41 is then processed by a membrane means 25 to produce a retained and purified natural gas product via line 44, which has a lower level of impurities relative to the second intermediate feed product via line 41, and a membrane permeate via line 34, which has a higher contaminant level than the second intermediate feed product. The membrane permeate via line 34 contains some natural gas that is recovered by mixing the membrane permeate via line 34 with the feed 1 via line 74. The recycle of the membrane permeate line 34 is optional and the tail gas may be directed to leave the system as an impurity containing stream. Further the feed to the membrane unit 25 may be compressed prior to the membrane

FIG. 4B illustrates a similar flow as FIG. 4A, except that the membrane permeate via line 34 is compressed by a compressor 52 and mixed via line 72 with the intermediate feed product at line 12 to recover additional purified natural gas. The recycle of the membrane permeate line 34 is optional and the tail gas may be directed to leave the system as an impurity containing stream. Further the feed to the membrane unit 25 may be compressed prior to the membrane

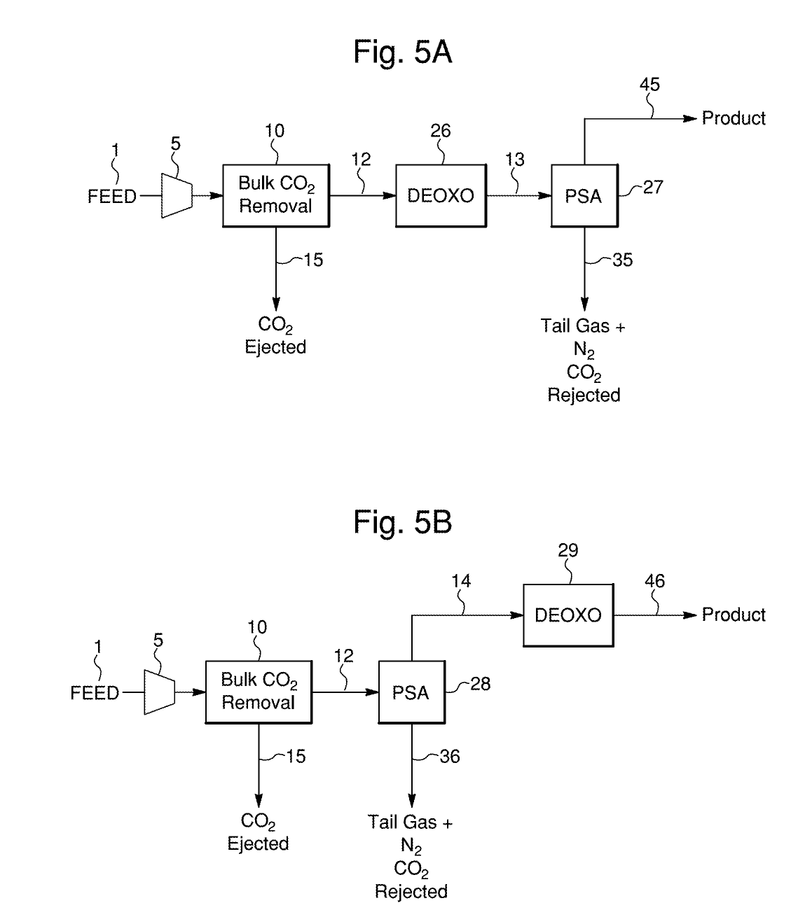

FIG. 5A illustrates a contaminated natural gas stream purification procedure that is comprised of three stages. Initially, a contaminated natural gas stream 1 is compressed by compressor 5 then transmitted to means 10 for BCDR, which is comprised of at least one non-membrane gas separator means, such as solvent-based wash systems, molecular sieves, carbon ion pumps and PSA systems. The BCDR means 10 then ejects CO₂ via line 15. An intermediate feed product is transmitted to a second stage Deoxo means 26 via line 12, which processes the first intermediate feed product to produce the second intermediate feed product. This secondary intermediate feed product is then transmitted to a third stage PSA means 27 via line 13. The PSA means 27 produces a product gas via line 45, and a tail gas containing N₂ and residual CO₂ via line 35.

FIG. 5B illustrates a contaminated natural gas stream purification procedure that is comprised of three stages. Initially, a contaminated natural gas stream 1 is compressed by compressor 5 then transmitted to means 10 for BCDR, which is comprised of at least one non-membrane gas separator means, such as solvent-based wash systems, molecular sieves, carbon ion pumps and PSA systems. The BCDR means 10 then ejects CO₂ via line 15. An intermediate feed product is transmitted to a second stage PSA means 28 via line 12, which processes the first intermediate feed product to produce a tail gas containing N₂ and residual CO₂ via line 36, and an intermediate product gas. This intermediate product gas is then transmitted to a third stage Deoxo means 30 via line 14. The Deoxo means 29 produces a product gas via line 46.

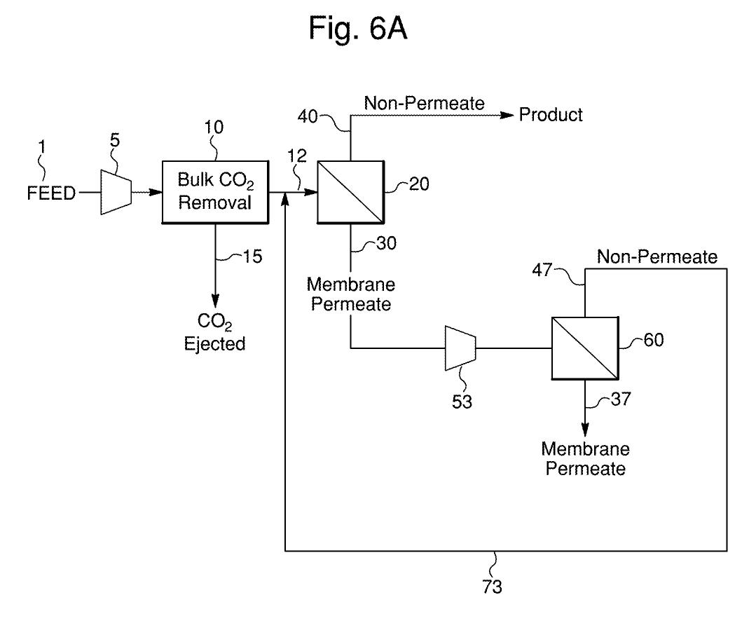

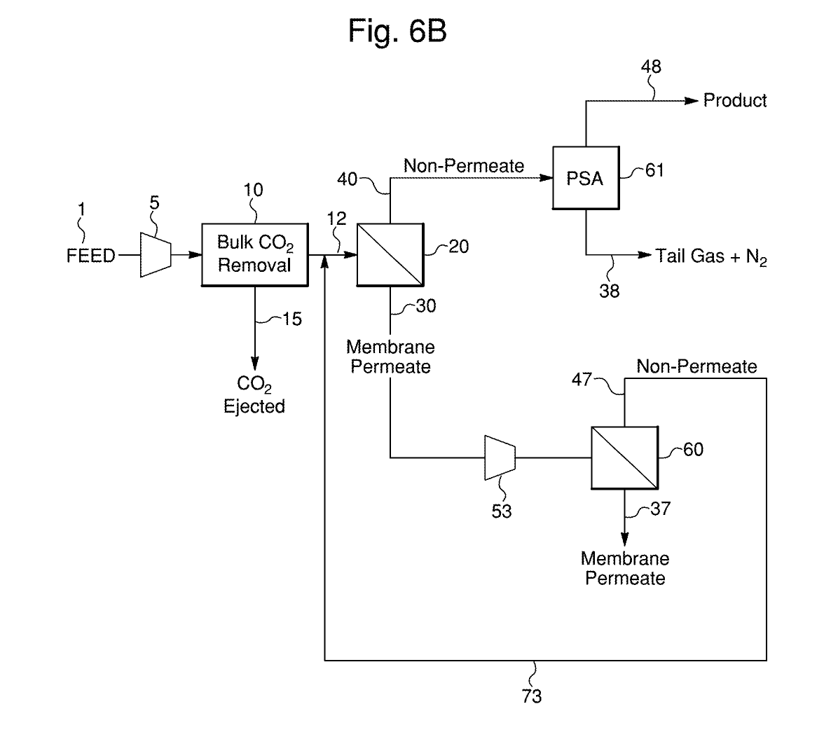

FIG. 6A illustrates a contaminated natural gas stream purification procedure that is comprised of three stages. Initially, a contaminated natural gas stream 1 is compressed by compressor 5 then transmitted to means 10 for BCDR, which is comprised of at least one non-membrane gas separation means, such as solvent-based wash systems, molecular sieves, carbon ion pumps and PSA systems. The BCDR means 10 then ejects CO₂ via line 15. An intermediate feed product from the BCDR means 10 is transmitted to a second stage via line 12, wherein a membrane means 20 further processes the intermediate feed product to produce a retained and purified natural gas product (non-permeate) via line 40, which has a lower level of O₂ relative to the intermediate feed product, and a membrane permeate via line 30, which has a higher level of O₂ relative to the intermediate feed product. The membrane permeate comprises natural gas, O₂, and other impurities. The membrane permeate is then compressed by compressor 53 and further processed by a third stage membrane means 60. The membrane means 60 produces a membrane permeate via line 37 and a natural gas non-permeate via line 47, which is then mixed via line 73 with the intermediate feed product at line 12 to recover additional natural gas volume.

FIG. 6B illustrates a contaminated natural gas stream purification procedure that is comprised of four stages. Initially, a contaminated natural gas stream 1 is compressed by compressor 5 then transmitted to means 10 for BCDR, which is comprised of at least one non-membrane gas separation means, such as solvent-based wash systems, molecular sieves, carbon ion pumps and PSA systems. The BCDR means 10 then ejects CO₂ via line 15. An intermediate feed product from the BCDR means 10 is transmitted to a second stage via line 12, wherein a membrane means 20 further processes the intermediate feed product to produce a retained and purified natural gas product (non-permeate) via line 40, which has a lower level of O₂ relative to the intermediate feed product, and a membrane permeate via line 30, which has a higher level of O₂ relative to the intermediate feed product. The membrane permeate comprises some natural gas, O₂, and other impurities. The non-permeate is processed by a fourth stage PSA means 61. The PSA means 61 produces a purified natural gas product gas via line 48 and a tail gas that contains N₂ via line 38. The membrane permeate via line 30 is compressed by compressor 53 and further processed by a third stage membrane means 60 to recover additional natural gas. The membrane means 60 produces a membrane permeate via line 37 that contains contaminants such as CO₂ and O₂, and non-permeate via line 47, which is then mixed via line 73 with the intermediate feed product at line 12 for further natural gas recovery.

### Case Data

The gas purification procedure in FIG. 1A produces a desirable product gas with low impurities. Table 1 below shows the final specifications (mole %) of the product gas as produced, as well as the amount of impurities that were present in the contaminated natural gas and subsequently removed from the product gas:

TABLE 1

| | 1 | 2 | | | |
|---|---|---|---|---|---|
| | Feed to | Bulk CO₂ | 3 | 4 | 5 |
| | Bulk CO₂ | Product | CO₂ | Membrane | Membrane |
| | Removal | Stream | Rejected | Product | Permeate |
| Flow, SCFM | 100 | 58.2 | 41.8 | 39.4 | 18.8 |
| Pressure, psig | 200 | 190 | Near ATM | 180 | Near ATM |
| Temperature, | Per | Per | Per | Near inlet | Near inlet |
| ° F. | technology | technology | technology | temperature | temperature |
| | used | used | used | | |
| C₁ | 52.00 | 87.56 | 2.49 | 91.31 | 79.66 |
| N₂ | 5.00 | 8.42 | 0.24 | 7.32 | 10.73 |
| CO₂ | 41.50 | 1.50 | 97.20 | 0.37 | 3.88 |
| O₂ | 1.50 | 2.53 | 0.07 | 1.00 | 5.73 |

1. A method for removing impurities from a natural gas stream, comprising:
1) removing the bulk of carbon dioxide from a natural gas feed stream by at least one non-membrane gas separation means to yield an intermediate natural gas product having a lower amount of CO₂ relative to said feed stream; and 2) removing oxygen and optionally other impurities from said intermediate natural gas product in at least one additional gas separation means to form a purified natural gas product.

2. The method of claim 1, wherein said natural gas feed stream is derived from natural gas wells, mines, gas associated with the production of oil, or digesters and landfills.

3. The method of claim 1, wherein at least 25% of said carbon dioxide in said natural gas feed stream is removed during said step 1).

4. The method of claim 1, wherein at least 50% of said carbon dioxide in said natural gas feed stream is removed during said step 1).

5. The method of claim 1, wherein said other impurities comprise nitrogen, hydrogen, residual oxygen and carbon dioxide, sulfur-containing compounds, water, VOCs, siloxanes and mixtures thereof.

6. The method of claim 1, wherein said natural gas feed stream is compressed before it is processed in said step 1).

7. The method of claim 1, wherein said step 1) comprises at least one means that is selected from solvent-based wash systems, CO2 refrigeration systems, molecular sieves, carbon ion pumps and PSA systems.

8. The method of claim 7, wherein said step 1) comprises a PSA system.

9. The method of claim 8, wherein said step 1) comprises a PSA system containing a carbon molecular sieve adsorbent.

10. The method of claim 8, wherein said PSA system further includes an adsorbent to remove nitrogen.

11. The method of claim 1, wherein said step 2) reduces oxygen in the natural gas product to a level of up to about 5,000 ppm.

12. The method of claim 1, wherein said additional gas separation means of said step 2) is selected from membrane permeation, catalyst-assisted combustion, metal adsorption, deoxo catalysts, PSA systems and combinations thereof.

13. The method of claim 12, wherein said additional gas separation means of said step 2) comprises at least one membrane permeation system.

14. The method of claim 12, wherein said additional gas separation means of said step 2) comprises at least one said PSA system.

15. The method of claim 14, wherein said PSA system further includes at least one means to adsorb nitrogen.

16. The method of claim 12, wherein said additional gas separation means of said step 2) comprises a combination of at least one PSA system and at least one membrane permeation system.

17. The method of claim 12, wherein said additional gas separation means of said step 2) comprises a combination of at least one deoxo system and at least one PSA system.

18. The method of claim 1, wherein said step 2) produces a purified natural gas stream and a contaminant stream containing natural gas, further processing said contaminant stream in said step 1) and/or said step 2).

19. The method of claim 5, wherein said oxygen is removed by one or more deoxo catalysts selected from copper oxide on a high surface area alumina sphere carrier, palladium on an alumina carrier, palladium on a special Al₂O₃ carrier, and a mixed metal catalyst that is composed of CuO and ZnO.

20. The method of claim 19, wherein said catalysts is placed after said step 1).

21. The method of claim 19, wherein said catalysts is placed after said step 2).
